(19) United States
(12) Patent Application Publication
(10) Pub. No.: US 2012/0213876 A1
(43) Pub. Date: Aug. 23, 2012

(54) DEVICE FOR PRODUCING GRANULES MADE OF POLYMERIC MATERIALS

(75) Inventors: Bernhard STARK, Fronreute (DE); Michael AHLGRIMM, Besigheim (DE); Markus NICKLAS, Nussloch (DE); Olaf HUSTERT, Weingarten (DE); Michael DÜRR, Wolfegg (DE); Günther DEHM, Bergatreute (DE)

(73) Assignee: COPERION GMBH, Stuttgart (DE)

(21) Appl. No.: 13/366,680

(22) Filed: Feb. 6, 2012

(30) Foreign Application Priority Data
Feb. 18, 2011 (DE) 10 2011 004 429.9

(51) Int. Cl. B28B 17/00; B29B 9/16

(52) U.S. Cl. 425/10

(57) ABSTRACT

A device for producing granules has a water-cooled granulating mechanism for producing plastics material granules. A discharge line arranged downstream of the granulating mechanism discharges a starting mixture flow and a granule heat exchanger arranged downstream of the discharge line controls the temperature of the mixture containing the plastics material granules and cooling water using parallel fluid passages. The granule heat exchanger has an inlet and an outlet for a transmission heat exchanger medium. A drying mechanism arranged downstream of the granule heat exchanger dries the plastics material granules. The device also may have an energy recovery mechanism arranged downstream of the discharge line for recovering energy from a recovery cooling water flow, containing at least a part of the cooling water of the starting mixture flow. The device uses waste heat, transmitted to the cooling water to increase the performance of the device and improve the energy efficiency thereof.

### CROSS-REFERENCES TO RELATED APPLICATIONS

This application claims the priority of German Patent Application, Serial No. 10 2011 004 429.9, filed Feb. 18, 2011, pursuant to 35 U.S.C. 119(a)-(d), the content of which is incorporated herein by reference in its entirety as if fully set forth herein.

### FIELD OF THE INVENTION

The invention relates to a device for producing granules made of polymeric materials.

### BACKGROUND OF THE INVENTION

A device of this type is known from EP 1 522 395 A2, DE 43 37 205 A1, DE 198 24 788 A1 and DE 10 2008 023 046 A.

### SUMMARY OF THE INVENTION

An object of the present invention is to use waste heat, which is transmitted in the granulating mechanism to the cooling water, to increase the performance of the device or to improve its energy efficiency.

This object is achieved according to the invention, in accordance with a first aspect, by a device for producing granules made of polymeric materials with a water-cooled granulating mechanism for producing plastics material granules, with a discharge line arranged downstream of the granulating mechanism for discharging a starting mixture flow containing the plastics material granules and cooling water, with a granule heat exchanger arranged downstream of the discharge line for controlling the temperature of a temperature control mixture flow, containing the plastics material granules and at least a part of the cooling water, wherein the granule heat exchanger has an inlet for a transmission heat exchanger medium and an outlet for a transmission heat exchanger medium, and with a drying mechanism arranged downstream of the granule heat exchanger for drying the plastics material granules, wherein the granule heat exchanger has a plurality of fluid passages running in parallel, in other words not in series, for the temperature mixture flow, and, in accordance with a second aspect, by a device for producing granules made of polymeric materials with a water-cooled granulating mechanism for producing plastics material granules, with a discharge line arranged downstream of the granulating mechanism for discharging a starting mixture flow, containing the plastics material granules and cooling water, and with an energy recovery mechanism, which is arranged downstream of the discharge line, for recovering energy from a recovery cooling water flow, containing at least a part of the cooling water of the starting mixture flow, wherein the energy recovery mechanism comprises at least one ORC circuit for an ORC circuit medium comprising an ORC turbine, an ORC evaporator in the ORC circuit before the ORC turbine, and an ORC condenser in the ORC circuit after the ORC-turbine.

It was recognized according to the invention that a heat exchanger for controlling the temperature of a plastics material granule/cooling water mixture flow can be used to improve the quality of the granule production process. The granule heat exchanger can cool or heat the temperature control mixture flow. The device can be designed in such a way that the granule heat exchanger can optionally cool or heat in a controlled manner.

Cooling with the granule heat exchanger can, for example, avoid the formation of vacuoles, as the cooling water can be guided at a higher temperature through the granulating mechanism. This can contribute to a more flexible influencing of a cooling speed and therefore of a shrinking behavior of the granules. A formation of crystalline and amorphous structures in the plastics material granules produced can either be forced in a targeted manner by specifying a cooling speed or else avoided if a structure formation of this type is undesired. By cooling using the granule heat exchanger, a soft plastics material product can be cooled in order to improve its pneumatic conveying behavior during pneumatic conveyance used in the granule conveying path after the device with regard to loss of pressure and with regard to granule abrasion. The heating of the transmission heat carrier medium taking place in the cooling granule heat exchanger can be used to preheat a plastics material powder or plastics material granules, which are fed to an extruder of the granulating mechanism as starting products. The heat transmitted in the cooling granule heat exchanger to the transmission heat carrier medium can be used with the aid of an absorption refrigerating machine to produce cold water.

If the granule heat exchanger is used to heat the temperature control mixture flow, the latter can be used to degas or deodorize hydrocarbons and residue monomers or other volatile materials. The heating of the plastics material granules can be used to improve or accelerate a degassing, for example of polyolefins such as, for example, PP, HDPE (High Density Polyethylene), LLDPE (Linear Low Density Polyethylene), LDPE (Low Density Polyethylene), LDPE with a vinyl acetate fraction or else other comonomers. The heating of the temperature control mixture flow with the granule heat exchanger can also be used to crystallize PET, in particular in the form of chips. The cooling of the plastics material granules with the granule heat exchanger can be used to heat a downstream hydraulic conveyance of the plastics material granules. The hydraulic medium of the hydraulic conveyance is heated here using the waste heat of the temperature control mixture flow in the granule heat exchanger. Heat losses of the hydraulic conveyance can be compensated by this.

The granule heat exchanger can be configured as a tube bundle heat exchanger. The tubes of the tube bundle may run straight or else in a U-shape. The tubes may have a typical internal diameter that is 5 to 15 times as large as the typical diameter of the granule grains produced. Tubes with a non-round cross-section may also be used as heat exchanger tubes. The tubes may, for example, have a rectangular cross-section. The granule heat exchanger may also be configured as a plate heat exchanger. An example of a plate heat exchanger of this type is given in EP 0 444 338 B1. In the configuration as a plate heat exchanger, the transmission heat exchanger medium can flow in the plates of the plate heat exchanger and the temperature control mixture flow can flow between the plates of the plate heat exchanger.

A bypass line, which bridges the granule heat exchanger between the granulating mechanism and the drying mechanism, ensures reliable operation of the device. A quantity control unit may be provided to specify a fluid quantity distribution between the granule heat exchanger and the bypass line. The quantity control unit can be realized by a deflector, by controllable valves, on the one hand, after a branch of the bypass line and before the granule heat exchanger and, on the other hand, in the bypass line, or can also be realized by at least one squeeze valve at one of the two aforementioned valve positions.

A conveying direction counter to an effect of gravity, in which the temperature control mixture flow is conveyed through the fluid passages, is particularly suitable in granules, the specific weight of which is less than that of the cooling water.

A conveying direction in the direction of gravity, in which the temperature control mixture flow is conveyed through the fluid passages under the influence of gravity, is particularly suitable in granulates, the specific weight of which is higher than that of the cooling water. The conveying direction in the direction of gravity allows a counter-flow of the transmission heat carrier medium of the granule heat exchanger counter to a direction of gravity, so that the transmission heat carrier medium within the granule heat exchanger can be evaporated. This possibility of evaporation may be advantageous for specific applications of the granule heat exchanger.

A concentrating mechanism, the entry of which is fed by the discharge line and which has a first exit for a cooling water flow and a second exit for the temperature control mixture flow, wherein the first exit of the concentrating mechanism has a fluid connection to a return line for the cooling water to the granulating mechanism, the second exit of the concentrating mechanism has a fluid connection to the granule heat exchanger, increases the efficiency of a heat transmission between the plastics material granules and the transmission heat carrier medium in the granule heat exchanger. A temperature influence on the plastics material granules can therefore be increased, assuming a given design of the granule heat exchanger.

An integration of the concentrating mechanism at the entry of the granule heat exchanger is compact and leads to low heat losses. The concentrating mechanism may be arranged in the region of an expansion portion of a container wall of the granule heat exchanger. An annular line at the entry of the granule heat exchanger may be a component of the concentrating mechanism. The annular line can be separated from the interior of the expansion portion by a retaining sieve.

A cooling water heat exchanger arranged in the return line between the concentrating mechanism and the granulating mechanism can be used to control the temperature of the cooling water. If necessary, the cooling water can be cooled using the cooling water heat exchanger. The energy, which is absorbed by a transmission heat exchanger medium of the cooling water heat exchanger, can be recovered.

A connection of the granule heat exchanger, in which the inlet of the granule heat exchanger for the transmission heat exchanger medium has a fluid connection to a separation line, which is arranged downstream of the drying mechanism, for separated cooling water, and in which the outlet of the granule heat exchanger for the transmission heat exchanger medium has a fluid connection to a return line for the cooling water to the granulating mechanism, to a separator line after the drying mechanism of the device can be used to heat the temperature control mixture flow in the granule heat exchanger. In this case, the cooling water itself is used as the transmission heat exchanger medium of the granule heat exchanger. An arrangement of this type is particularly advantageous when using the granule heat exchanger to degas or deodorize the plastics material granules.

According to the second aspect of the invention it was recognized that an ORC circuit (Organic Rankine Cycle) is a particularly advantageous variant for using the heat contained in the recovery cooling water flow. The recovery cooling water flow may be the temperature control mixture flow already mentioned above, containing the plastics material granules and at least a part of the cooling water and/or a cooling water flow after a separation of cooling water from the starting mixture flow and/or the starting mixture flow itself. The energy recovery mechanism reduces the energy consumption of the total system. A pump may be arranged in the ORC system. This pump may be used to compress the organic medium. The ORC circuit may be designed in such a way that no condensation of the ORC circuit medium takes place in the ORC turbine. The ORC turbine may work as an expansion turbine.

As an alternative to an ORC circuit, a heat carrier medium circuit with a heat carrier medium or heat exchanger medium based on a salt solution may be used. In general, the temperature control mixture flow can be used to expel a refrigerant, for example water or NH₃, from a sorption agent, which may be, for example, lithium bromide, an ionic liquid or else water.

A two-stage ORC evaporator of the organic medium, in which the ORC evaporator has an ORC evaporator unit in the ORC circuit before the ORC turbine and an ORC preheater unit in the ORC circuit before the ORC evaporator unit, the ORC evaporator unit and/or the ORC preheater unit being configured as a heat exchanger with the recovery cooling water flow, is particularly well adapted to the requirements of the ORC circuit medium.

A restrictor may be arranged between the ORC preheater unit and the ORC evaporator unit.

A design, comprising an ORC cooler in the ORC circuit between the ORC turbine and the ORC condenser for emitting heat from the ORC circuit medium to a transmission heat exchanger medium, and comprising an ORC preliminary preheater in the ORC circuit between the ORC condenser and the ORC evaporator for emitting heat from the transmission heat exchanger medium to the ORC circuit medium, uses the heat contained in the ORC circuit medium at the exit of the ORC turbine for preliminary preheating of the ORC circuit medium after the condensation and therefore increases the efficiency of the ORC circuit.

A concentrating mechanism, the entry of which is fed by the discharge line and which has a first exit for a cooling water flow and a second exit for a mixture flow, containing plastics material granules and cooling water with a higher granule fraction than the starting mixture flow, the first exit (49) of the concentrating mechanism having a fluid connection to the ORC evaporator, leads to the possibility of using separately the thermal energy, which, on the one hand, is contained in the cooling water flow, which is guided away via the first exit, and which, on the other hand, is guided away in the mixture flow via the second exit.

A possible use of the energy of the mixture flow is produced by the configuration, in which the ORC preheater unit has a fluid connection to the second exit of the concentrating mechanism.

An ORC circuit medium, having an evaporation enthalpy in the range between 0 and 2600 kJ/kg and/or a heat capacity in the range between 0 and 6 kJ/kgK, has proven to be well adapted to the requirements of an ORC circuit for the energy recovery mechanism in the device. A high heat capacity of the ORC circuit medium reduces the required circulating quantity of the circuit medium and thereby reduces the required overall size of the components in the energy recovery mechanism. The high heat capacity of the ORC circuit medium, if present, in the preheater, removes a correspondingly high heat fraction from the cooling water or from the mixture flow. The ORC circuit medium may have a dry, retrograde expansion behavior, i.e. a saturated steam curve with a positive gradient beyond a critical point in the T/S graph of the ORC circuit medium. The ORC circuit medium can be operated in a temperature range between 10° C. and 120° C. and in a pressure range between 1 bar and 16 bar. R245fa, isobutane or isobutene may be used as the ORC circuit medium.

A bypass line, which bridges the energy recovery mechanism between the granulating mechanism and a drying mechanism, ensures reliable operation of the device with the energy recovery mechanism.

The above-described features regarding the two aspects of the device can also be realized in any combination with one another.

Embodiments of the invention will be described in more detail below with the aid of the drawings.

### BRIEF DESCRIPTION OF THE DRAWINGS

FIG. 1 schematically shows a general plan of a device for producing granules made of polymeric materials, in other words a plastics material granulating system;

FIG. 2 shows, in a view similar to FIG. 1, a general plan of an alternative plastics material granulating system;

FIG. 3 shows, in a view similar to FIG. 1, a general plan of an alternative plastics material granulating system;

FIG. 4 shows an embodiment of a concentrating mechanism, which can be used as an alternative to a concentrating mechanism which is shown in FIG. 3;

FIG. 5 shows, in a view similar to FIG. 1, a general plan of an alternative plastics material granulating system;

FIG. 6 shows, in a view similar to FIG. 1, a general plan of an alternative plastics material granulating system; and

FIG. 7 to 9 in a view similar to FIG. 1, in each case, shows a general plan of alternative plastics material granulating systems.

### DESCRIPTION OF THE PREFERRED EMBODIMENTS

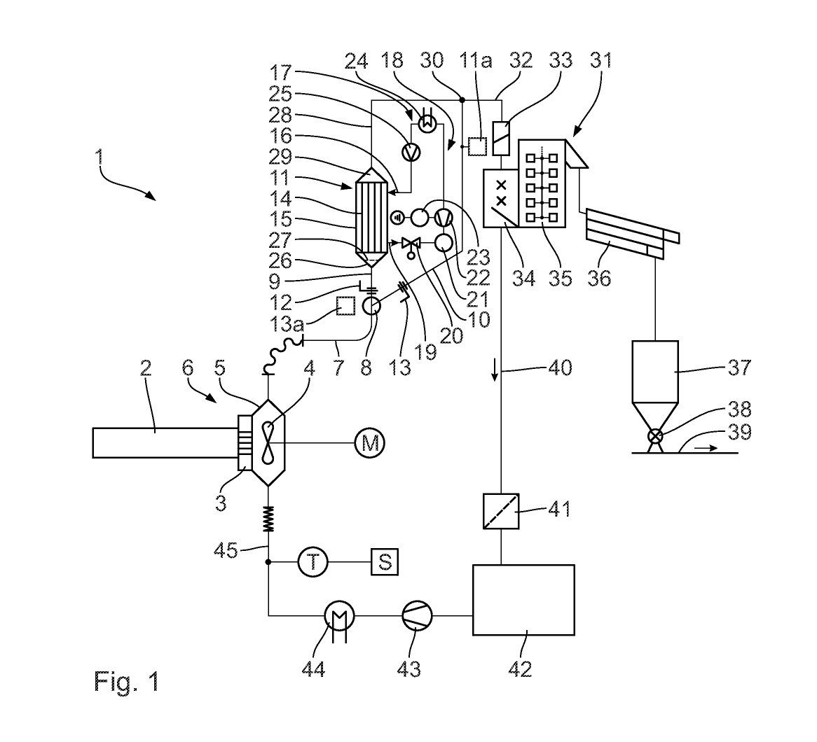

FIG. 1 shows a first configuration of a device 1 for producing granules made of polymeric materials. The device 1 is also called a plastics material granulating system.

The device 1 has an extruder 2 for producing a polymer melt. A melt pump can also be provided as an alternative to an extruder.

A perforated plate 3, through which the polymer melt is pressed, is arranged at the exit of the extruder 2. A cutting mechanism 4 is arranged in the conveying path of the polymer melt directly behind the perforated plate 3. The cutting mechanism 3 cuts the individual polymer strands formed in the perforated plate 3 into individual granule grains. The cutting process takes place in a granulating hood 5, through which cooling water is guided to cool the cut granules, said cooling water also being called granulating water. The extruder 2, the perforated plate 3, the cutting mechanism 4 and the granulating hood 5 are components of a water-cooled granulating mechanism 6 for producing the plastics material granules. A discharge line 7, which has a fluid connection to an exit of the granulating hood 5, is arranged downstream of the granulating hood 5 in the conveying path of the cooling water. The discharge line 7 is used to discharge a starting mixture flow from the granulating hood 5, which flow contains the plastics material granules produced and the cooling water guided through the granulating hood 5.

A bypass branch 8 is arranged in the further conveying path of the discharge line 7. The discharge line 7 branches there into a heat exchanger feed line 9 and into a bypass line 10. The heat exchanger feed line 9 has a fluid connection to the granule heat exchanger 11. The latter is used to control the temperature of a temperature control mixture flow, containing the plastics material granules produced and at least a part of the cooling water. A quantity control unit is used to specify a fluid quantity distribution between the granule heat exchanger 11 and the bypass line 10. A water volume flow in the bypass line 10 can be measured by a throughflow sensor 11a. The quantity control unit can be realized as an adaptable deflector unit at the site of the bypass branch 8. As an alternative, the quantity control unit can be realized by controllable valves or shut off members 12, 13, for example in the form of flaps or slides. The shut off member 12 is arranged in the conveying path of the temperature control mixture flow between the bypass branch 8 and the granule heat exchanger 11. The shut off member 13 is arranged in the bypass line 10 after the bypass branch 8. In a further variant, the quantity control unit can be realized by a squeeze valve either at the site of the shut off member 12 or at the site of the shut off member 13. A regulating unit 13a can have a control or signal connection with the shut off members 12, 13 of the squeeze valve. This connection is not shown in the drawing. The regulating unit 13a also has a signal connection, in a manner also not shown, with the throughflow sensor 11a. In the regulating unit 13a, an actual throughflow value through the bypass line 10, which is measured by the throughflow sensor 11a, is compared with a predetermined desired throughflow value and, if the deviation exceeds a predetermined tolerance value, is regulated by activating the deflector unit, the shut off members 12, 13 or the squeeze valve to the desired value.

The granule heat exchanger 11 is used for heat exchange between the temperature control mixture flow and an ORC (Organic Rankine Cycle) circuit medium. The ORC circuit medium is a transmission heat exchanger medium for heat transmission in the granule heat exchanger 11. The granule heat exchanger 11 is configured as a tube bundle heat exchanger. The temperature control mixture flow is conveyed from bottom to top, in other words counter to an effect of gravity, by heat exchanger tubes 14 that run straight, of the tube bundle. The heat exchanger tubes 14, of the granule heat exchanger 11 are a plurality of fluid passages running in parallel, in other words not in series, for the temperature control mixture flow.

As an alternative to a straight course, the heat exchanger tubes 14 can also have a course bent in a U shape. The heat exchanger tubes 14 can have a diameter that is four to ten times as large as the typical diameter of the granule grains produced. Instead of a tube bundle heat exchanger the granule heat exchanger 11 can also be configured as a plate heat exchanger in the manner, for example, of EP 0 444 338 B1, which also has a plurality of fluid passages running in parallel for the temperature mixture flow.

In the upper region of a cylindrical heat exchanger container 15 of the granule heat exchanger 11, in which the tube bundle is arranged, an inlet 16 for the ORC circuit medium opens into the heat exchanger container 15. The inlet 16 is a component of an ORC circuit 17 of an energy recovery mechanism 18 for recovering energy from a recovery cooling water flow, which contains at least a part of the cooling water of the starting mixture flow. In the example of FIG. 1, the recovery cooling water flow is identical to the starting mixture flow when the by pass line 10 is closed.

An outlet 19 of the ORC circuit 17 opens out in the lower region of the heat exchanger container 15 from the latter. A restrictor 20 is arranged downstream from the outlet 19 in the conveying direction of the ORC circuit medium. The restrictor 20 keeps the ORC circuit medium in the granule heat exchanger 11 under a pressure that is sufficient for the ORC circuit medium in the granule heat exchanger 11 to not evaporate. An evaporator unit 21 is arranged downstream of the restrictor 20 in the conveying path of the ORC circuit medium in the ORC circuit 17. The evaporator unit 21 has an evaporator container and, in addition to the granule heat exchanger 11, which forms an ORC preheater unit, is a component of an ORC evaporator. An ORC turbine 22 is arranged downstream of the evaporator unit 21 in the conveying path of the ORC circuit medium in the ORC circuit 17. The ORC turbine 22 has a mechanical connection to a generator 23. The generator 23 feeds the current produced into a current network. An ORC condenser 24 is arranged downstream of the ORC turbine 22 in the conveying path of the ORC circuit medium in the ORC circuit 17. An ORC pump 25 for the circulating conveyance of the ORC circuit medium in the ORC circuit 17 is arranged downstream of the ORC condenser 24 in the conveying path of the ORC circuit 17.

The ORC circuit medium has an evaporation enthalpy in the range between 0 and 2600 kJ/kg and a heat capacity in the range between 0 and 6 kJ/kgK. The ORC circuit medium may have a dry, in other words retrograde, expansion behavior. The ORC circuit medium thus has a saturated steam curve with positive gradients in the T/S graph of the circuit medium. The T/S graph in this case gives the dependency between the absolute temperature T and the entropy S of the circuit medium. The ORC circuit 17 is operated in a temperature range between 10° C. and 120° C. and in a pressure range between 1 bar and 16 bar. R245fa and isobutane or isobutene are used as the ORC circuit medium.

In the region of an inlet-side expansion portion 26 of the heat exchanger container 15 between the heat exchanger feed line 9 and the tube bundle, a retaining sieve 27, with which plastics material agglomerates can be retained, is arranged in the flow path of the temperature control mixture flow.

A heat exchanger discharge line 28, which has a fluid connection with the tube bundle of the granule heat exchanger 11 via a constriction portion 29 of the heat exchanger container 15, unites with the bypass line 10 via a bypass mouth 30. The bypass line 10 thus bridges the granule heat exchanger 11 between the granulating mechanism 6 and a downstream drying mechanism 31 for drying the plastics material granules. Arranged at the entry of the drying mechanism 31 in a mixture flow line 32 running after the bypass mouth 30 for the temperature mixture flow, is an agglomerate separator 33. Arranged downstream thereof in the mixture flow line 32 is a granule water separator 34 with a dryer 35 arranged downstream in the conveying path of the plastics material granules. Arranged downstream of the dryer 35 in the granule conveying path, is a sieve machine 36 for sieving the dried plastics material granules. A granule container 37 in the form of a storage silo is arranged downstream of the sieve machine 36 in the conveying path of the granules. A delivery member in the form of a cellular wheel sluice 38 is arranged on the delivery side below the granule container 37. A conveying path 39 of an otherwise not shown pneumatic conveying system is arranged downstream of the cellular wheel sluice 38. Using the pneumatic conveying system, the produced and dried plastics material granules can be fed to a target site.

The cooling water separated in the granule-water separator 34 leaves the latter via a cooling water line 40. A sieve mechanism 41 is arranged therein in the further conveying path of the cooling water. Arranged downstream of the sieve mechanism 41 in the conveying path of the cooling water is a cooling water tank 42. A conveying pump 43 for the circulating circuit conveyance of the cooling water is arranged downstream of the cooling water tank 42 in the conveying path of the cooling water. A cooling water heat exchanger 44 is arranged downstream of the conveying pump 43 in the conveying path of the cooling water. From the cooling water heat exchanger 44, the cooling water is fed to the granulating hood 5 again via a feed line 45. Using the cooling water heat exchanger 44, the cooling water before the granulating hood 5 is brought to a predetermined granulating temperature. The cooling water temperature at the entry into the granulating hood 5 is typically 40° C. to 70° C. The cooling water is heated by heat exchange with the hotter granule grains, which are produced in the granulating mechanism 6, typically by 5K to 20K.

A temperature sensor T may be connected to the feed line 45. Said temperature sensor can measure an actual temperature of the cooling water at the entry of the granulating hood 5.

By means of the granule heat exchanger 11, an efficient preheating of the ORC circuit medium for the subsequent evaporation thereof in the evaporator unit 21 is ensured. The ORC circuit medium is preheated in the granule heat exchanger 11 in the cross counter flow. The current produced using the energy recovery mechanism 18 can be fed back into a supply network. As a result, a net current consumption of the overall system is correspondingly reduced. The current produced using the energy recovery mechanism 18 can be used, at least in part, to operate components of the plastics material granulating system, for example to operate the conveying pump 43, to operate a drive M of the cutting mechanism 4 or to operate the extruder 2. The cellular wheel sluice 38 can also be operated by the energy produced by the energy recovery mechanism 18.

When starting up the plastics material granulating system, the heat exchanger feed line 9 is closed and the starting mixture flow is firstly guided via the bypass line 10. The granule heat exchanger 11 can also be bridged via the bypass line 10 during operation of the system by corresponding adaptation.

A mesh size of the retaining sieve 27 is smaller than an internal diameter of the heat exchanger tubes 14.

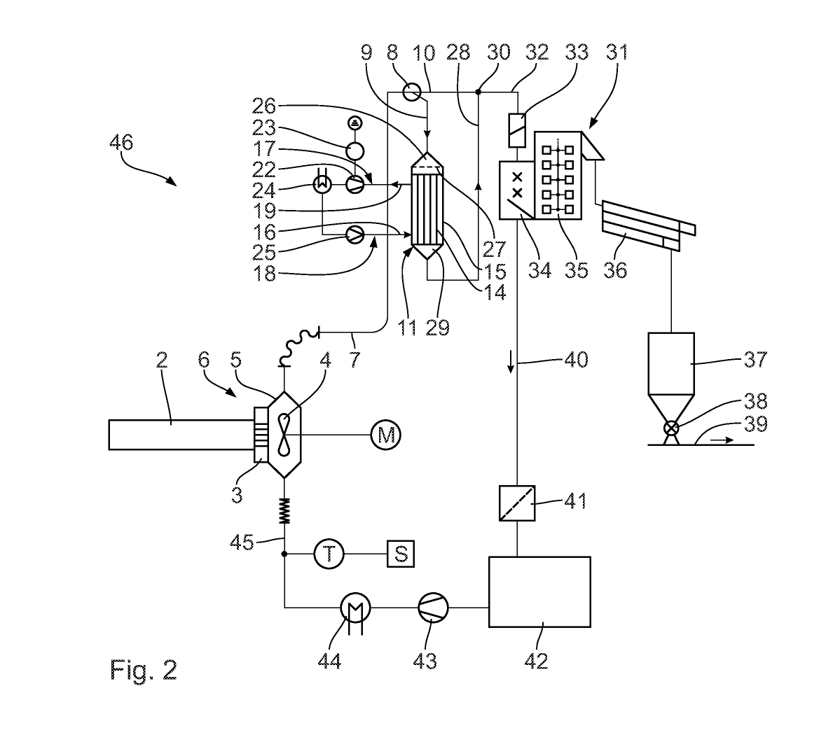

FIG. 2 shows an alternative configuration of a device 46 for producing granules made of polymeric materials, which can be used instead of the device 1. Components and function, which correspond to those which have already been described above with reference to FIG. 1, have the same reference numerals and will not be discussed again in detail.

In contrast to the conveyance of the temperature control mixture flow through the granule heat exchanger counter to the effect of gravity in the configuration according to FIG. 1, the conveyance of the temperature control mixture flow through the granule heat exchanger 11 in the configuration according to FIG. 2 takes place under the influence of gravity through the fluid passages, in other words through the heat exchanger tubes 14. In comparison to the arrangement according to FIG. 1, the granule heat exchanger 11 in the configuration according to FIG. 2 is thus arranged overhead. Accordingly, the inlet 16 for the ORC circuit medium is also arranged in the lower region of the heat exchanger container 15 and the outlet 19 is arranged in the upper region of the heat exchanger container 15. The granule heat exchanger 11 according to FIG. 2 can operate both as an ORC preheater unit and as an ORC evaporator unit. In the ORC circuit 17 according to FIG. 2, the granule heat exchanger 11 is simultaneously an ORC evaporator. The restrictor 20 in the ORC circuit 17 according to FIG. 1 can be dispensed with in the ORC circuit according to FIG. 2. The ORC evaporator unit 21 is also dispensed with in the ORC circuit 17 according to FIG. 2.

As an alternative to the arrangement possibilities of the granule heat exchanger 11 according to FIGS. 1 and 2, the granule heat exchanger 11 can also be configured with heat exchanger tubes 14 running horizontally or in a U shape or heat exchanger plates, which in each case predetermine a plurality of fluid passages running in parallel for the temperature control mixture flow.

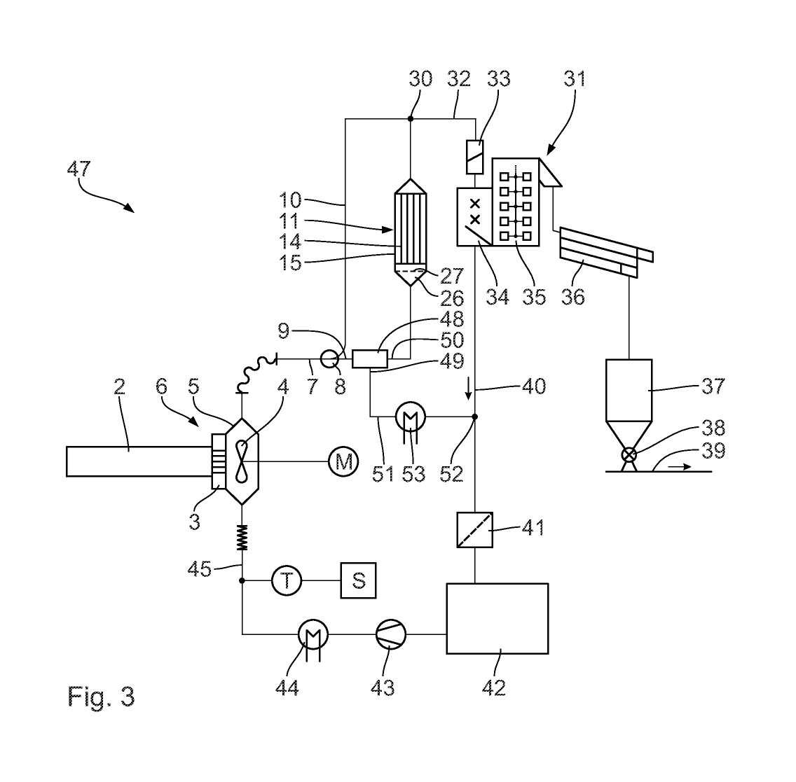

FIG. 3 shows an alternative configuration of a device 47 for producing granules made of polymeric materials, which can be used instead of the device 1. Components and functions, which correspond to those that have already been described above with reference to FIG. 1, have the same reference numerals and will not be discussed again in detail.

In FIG. 3, the ORC circuit 17, which, in the device 47 according to FIG. 3, can be configured precisely as in the device according to FIG. 1, is omitted.

In the device 47, a concentrating mechanism 48 is arranged in the conveying path of the temperature control mixture flow after the bypass branch 8. If the heat exchanger feed line 9 is at least partially open, a mixture flow entry of the concentrating mechanism 48 is fed by the discharge line 7. The concentrating mechanism 48 may be designed in the manner of that described in DE 100 61 892 C1.

The concentrating mechanism 48 has a first exit 49 for the further conveyance of a cooling water separated from the temperature control mixture flow in the concentrating mechanism 48 and a second exit 50 for the further conveyance of the concentrated temperature control mixture flow, which contains the produced plastics material granules and the non-separated part of the cooling water and is fed to the granule heat exchanger 11.

The first exit 49 of the concentrating mechanism 48, in other words the cooling water exit, has a fluid connection via an outlet tube line 51 and a cooling water mouth 52 to a cooling water line 40 between the granule-water separator 34 and the sieve mechanism 41. A further cooling water heat exchanger 53 is arranged in the outlet tube line 51. The outlet tube line 51 is a return line for the cooling water to the granulating mechanism 6. Comparably to the regulating of the cooling water flow in the bypass line 10, the volume flow in the outlet tube line 51 can also be regulated with the aid of a corresponding throughflow sensor in the outlet tube line 51 and corresponding adjusting fittings at the site of the concentrating mechanism 48 or shut off members in the exits 49, 50.

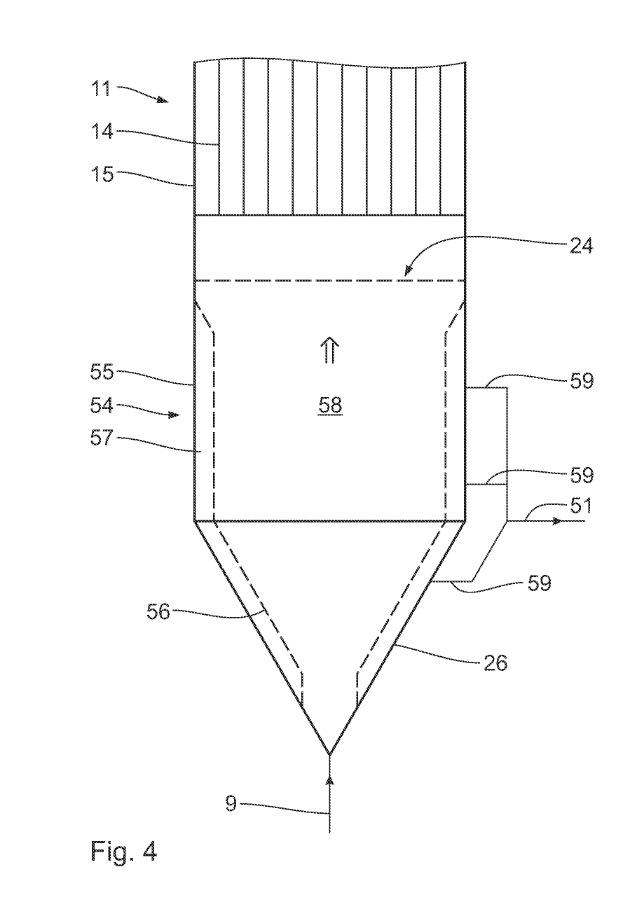

The concentrating mechanism 48 may alternatively also be integrated at the entry of the granule heat exchanger 11 into the latter. A configuration of this type of a concentrating mechanism 54, which can be used instead of the concentrating mechanism 48, is shown in FIG. 4. The concentrating mechanism 54 is arranged in the region of the expansion portion 26 and a lower portion 55 of the heat exchanger container 15 of the granule heat exchanger 11. Arranged spaced apart from an inner wall of the expansion portion 26 and of the lower portion 55 of the heat exchanger container 15 is a retaining sieve 56. This separates an annular line 57 for the cooling water separated in the concentrating mechanism 54 from the interior 58 of the heat exchanger container 15, so that the granules cannot enter the annular line 57. The annular line 57 has a fluid connection via a plurality of connecting line portions 59 with the outlet tube line 51. A part of the cooling water of the starting mixture flow is separated via the outlet tube line 51. The remainder of the cooling water remains in the temperature control mixture flow. The temperature control mixture flow thus concentrated can be more strongly cooled in the granule heat exchanger 11. The cooling water separated in the outlet tube line 51 can be cooled using the cooling water heat exchanger 53.

A line path of the discharge line 7 between the granulating hood 5 and the concentrating mechanism 48 or 54 is short and is, for example, only a few meters.

A heat exchanger power can be regulated by means of a control mechanism S, which has a signal connection to the temperature sensor T and the cooling water heat exchanger 44 and optionally with the cooling water heat exchanger 53 in such a way that the actual temperature of the cooling water at the entry of the granulating hood 5 coincides with a predetermined desired temperature within also predetermined limits.

A numerical example for the operation of the device 47 as a plastics material granulating system for polyolefins will be given below. A mass flow of 50 t/h polyolefin granules is granulated. An entry temperature of the granulating water into the granulating hood 5 is 80° C. A cooling water quantity transported in the cooling water circuit is 500 m³/h. In the starting mixture flow, the cooling water contained there is heated, by cooling the hot granules, to a temperature of about 95° C. The starting mixture flow is divided in the concentrating mechanism 48 or 54 into a cooling water part flow of 250 m³/h with a temperature of 95° C., which is conveyed onward via the outlet tube line 51, and into the temperature control mixture flow also of 250 m³/h cooling water, which is fed to the granule heat exchanger 11. The temperature control mixture flow emits heat to the ORC circuit medium. As a result, the temperature control mixture flow is cooled to a temperature of 65° C. During the subsequent drying of the plastics material granules contained in the temperature control mixture flow, the latter one dried more gently because of the cooling. Less abrasion or dust is generated during the drying. In the cooling water tank 42, the two cooling water part flows at 65° C. (separated in the granule water separator 34 or in the drying mechanism 31) and 95° C. (separated in the concentrating mechanism 48 or 54) are mixed producing a cooling water temperature of about 80° C. A temperature control of the cooling water using the cooling water heat exchanger 53 in the outlet tube line 51 is not necessary, so this cooling water heat exchanger 53 can also be dispensed with. Any residual temperature differences can be compensated by means of the cooling water heat exchanger 44.

A further numerical example in the operation of the device 47 as a plastics material granulating system will be described below during PC (polycarbonate) hot granulation. In this case, the cooling water enters the granulating hood 5 at a temperature of about 90° C. On leaving the granulating hood 5, the temperature control mixture flow has a temperature of 110° C. In the concentrating mechanism 48 or 54, the starting mixture flow is divided into an outlet cooling water flow through the outlet tube line 51, in which about half of the entire cooling water flow is conveyed, and into the temperature control mixture flow with the other half of the cooling water flow. In the granule heat exchanger 11, the temperature control mixture flow is cooled to about 70° C. The overheated cooling water flow is guided under geodetic excess pressure in the cooling water circuit.

In the cooling water tank 42, the two part flows at the temperatures of 70° C. and 110° C. mix to form a mean temperature of 90° C., which corresponds to the required temperature at the entry of the granulating hood 5.

In the granule heat exchanger 11, assuming a corresponding length of the heat exchanger tubes 14, a steam bubble formation can be avoided via the static water pressure even with an excess heating of the cooling water.

Instead of an ORC circuit 17, an energy recovery can also be realized by using a further heat exchanger for heating the cooling water if cooling water heating is required in the cooling water circuit, depending on the plastics material production process. The heating of the transmission heat exchanger medium in the granule heat exchanger 11 can also be used to operate a heat pump.

The cooling water heat exchanger 53 in the outlet tube line 51 can also be dispensed with in the PC heat granulation.

The operation of the device 47 will be described below using the example of the production of LDPE (Low Density Polyethylene) granules. The cooling water in this case enters the granulating hood 5 with a flow of 500 m³/h and a temperature of 60° C. At the exit of the granulating hood 5, the starting mixture flow has a temperature of about 75° C. In the concentrating mechanism 48 or 54, the starting mixture flow is divided into the temperature control mixture flow with 150 m³/h cooling water and into the outlet cooling water flow in the outlet tube line 51 with a flow of 350 m³/h cooling water. The temperature control mixture flow is heated to a temperature of 90° C. in the granule heat exchanger 11.

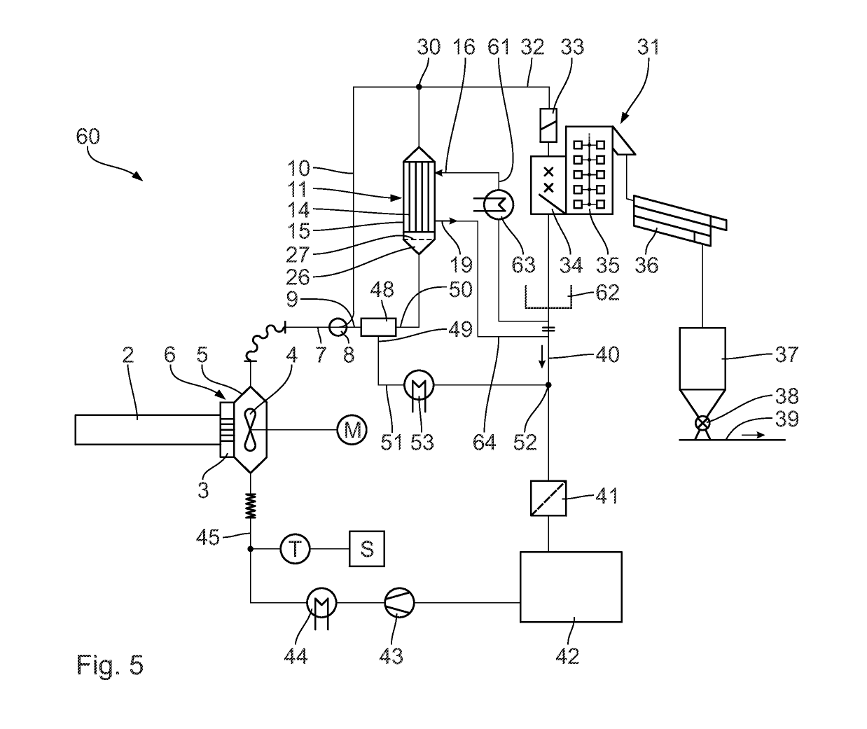

FIG. 5 shows an alternative configuration of a device 60 for producing granules made of polymeric materials, which can be used instead of the device 1. Components and functions, which correspond to those which have already been described above with reference to FIG. 1, have the same reference numerals and will not be discussed again in detail.

The ORC circuit is dispensed with in the device 60. The cooling water itself is used as the transmission heat exchanger medium, which exchanges its heat in the granule heat exchanger 11 with the temperature control mixture flow. The inlet 16 for the transmission heat exchanger medium has a fluid connection with the cooling water line 40 at the exit of the granule-water separator 34. Arranged in a feed line 61 for the transmission heat exchanger medium between the exit of the granule-water separator 34 and the inlet 16 in the conveying path of the cooling water is firstly a cooling water intermediate container 62 and, in the further conveying path, a preheat exchanger 63 for heating the cooling water before the inlet 16.

The outlet 19 for the transmission heat exchanger medium has a fluid connection via a return line 64 with the portion of the cooling water line 40 to the cooling water tank 42. The cooling water mouth 52 of the discharge tube line 51 is also arranged in this portion.

The temperature control mixture flow leaving the granule heat exchanger 11 enters the drying mechanism 31. The cooling water separated there is heated in the preheat exchanger 63 to a temperature of 100° C. and is used to heat the LDPE granules produced in the granule heat exchanger 11 to degas the LDPE. In this case, the transmission heat exchanger medium cools to 85° C. The two cooling water heat exchangers 44 and 53 are operated in such a way that the cooling water in the feed line 45 and at the entry of the granulating hood 5 again has the required temperature of 60° C.

In the device 60, the granule container 37 is configured a degassing silo.

The LDPE may have the copolymer ethylene vinyl acetate. The water temperature for granulation in the granulating hood 5 is lowered with the increasing content of ethylene vinyl acetate copolymer.

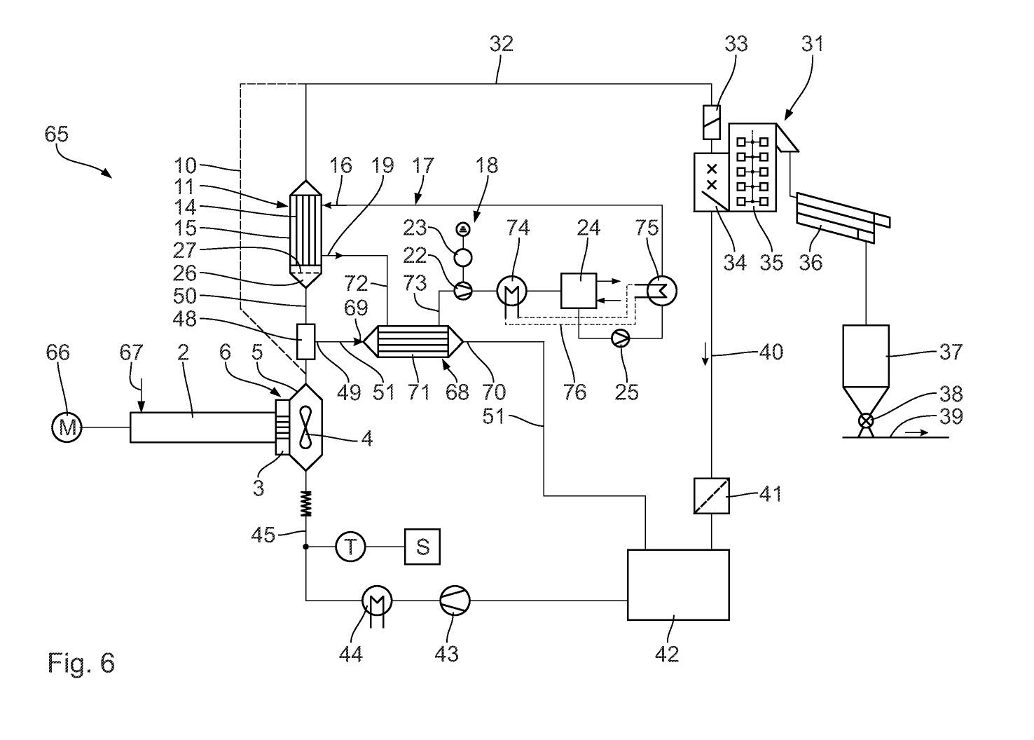

FIG. 6 shows an alternative configuration of a device 65 for producing granules made of polymeric materials, which can be used in place of the device 1. Components and functions, which correspond to those which have already been described above with reference to FIG. 1, have the same reference numerals and will not be discussed again in detail.

A drive motor 66 for the extruder 2 is shown in FIG. 6. A feed of powdery starting material for the extrusion in the extruder 2 is indicated schematically by an arrow 67 in FIG. 6.

An ORC evaporator, in the device 65, apart from the granule heat exchanger 11, as the ORC preheater unit, also comprises an ORC evaporator unit 68, which is arranged in the ORC circuit 17 between the granule heat exchanger 11 and the ORC turbine 22. The ORC evaporator unit 68 is arranged in the outlet tube line 51 of the concentrating mechanism 48. The ORC evaporator unit 68 has a cooling water entry 69 and a cooling water exit 70. The ORC evaporator unit 68 is also configured, comparably to the granule heat exchanger mechanism 11, as a tube bundle heat exchanger with horizontally extending heat exchanger tubes, in which the cooling water is guided back and forth between the cooling water entry 69 and the cooling water exit 70 in a plurality of paths. Other designs of the evaporator unit 68 are also possible. An ORC inlet 72 of the ORC circuit 17 opens into an evaporator container 71 of the ORC evaporator unit 68 on the casing side and an ORC outlet 73 of the ORC circuit 17 opens out therefrom. FIG. 6 indicates a heat exchanger operation of the ORC evaporator unit 68 in co-current flow. A counter-current flow operation of the heat transmission between the cooling water and the ORC circuit medium in the ORC evaporator unit 68 is also possible.

Arranged in the ORC circuit 17 between the ORC turbine 22 and the ORC condenser 24 is an ORC cooler 74 for emitting heat from the ORC circuit medium to a further transmission heat exchanger medium, for example to water. Arranged in the ORC circuit 17 between the ORC pump 25 and the granule heat exchanger 11 is an ORC preheater 75 to emit heat from the further transmission heat exchanger medium to the ORC circuit medium. The ORC cooler 74 has a fluid connection with the ORC preheater 75 via a transmission heat exchanger medium circuit 76, which is shown by dashed lines in FIG. 6.

In the device 65, the first exit 49 of the concentrating mechanism 48 has a fluid connection with the ORC evaporator unit 68. The ORC preheating unit, in other words the granule heat exchanger 11, has a fluid connection with the second exit 50 of the concentrating mechanism 48.

As indicated by dashed lines in FIG. 6, the device 65 may also have a bypass line 10 between the granulating mechanism 6 and the drying mechanism 31.

A numerical example in the production of polyolefin granules with the device 65 will in turn be given below: The cooling water enters the granulating hood 5 at a temperature of 80° C. and a cooling water flow of 500 m³/h. The granulating mechanism 6 produces a mass flow of 50 t/h polyolefin granules. The starting mixture flow leaves the granulating hood 5 at a temperature of 93° C. A division of the starting mixture flow takes place in the concentrating mechanism 48 into a cooling water flow in the outlet tube line 51 of 400 m³/h and into the temperature control mixture flow with a water fraction of 100 m³/h. The temperature control mixture flow consists of a cooling water flow of 100 m³/h and a plastics material granule volume flow of 50 m³/h to 55 m³/h. In the granule heat exchanger 11, the temperature control mixture flow is cooled to 75° C. In the ORC evaporator unit 68, the cooling water entering at a temperature of 93° C. is cooled to a temperature of 82° C. In the drying mechanism 31, the polyolefin granules are separated, so a production of 50 t/h is realized. The cooling water separated in the drying mechanism 31 at a temperature of 75° C. and the cooling water leaving the ORC evaporator unit 68 at a temperature of 82° C. mix to a mixing temperature in the cooling water tank 42 of about 80° C. Basically, further heat exchangers to regulate the cooling water temperature in the device 65 can be dispensed with. Alternatively, it is possible to provide the heat exchangers 44 or 53, on the one hand, in the feed line 45 and, on the other hand, in the outlet tube line 51 between the ORC evaporator unit 68 and the cooling water tank 42. This may be used to operate the device 65 without the ORC circuit 17.

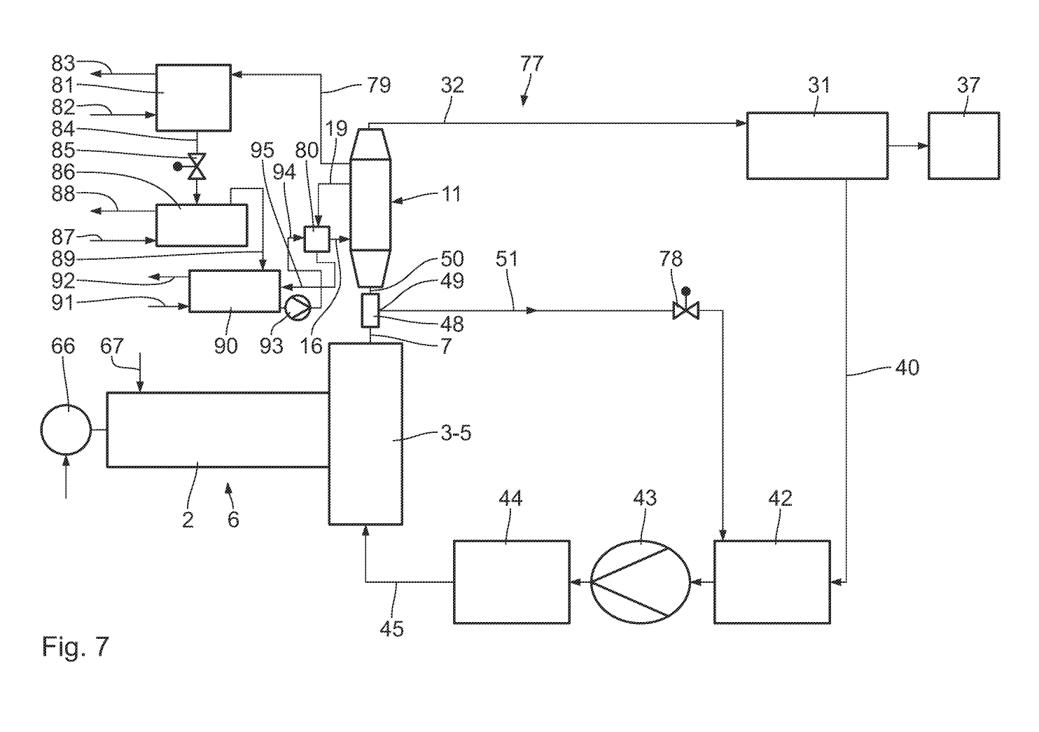

FIG. 7 shows an alternative configuration of a device 77 for producing granules made of polymeric materials, which can be used instead of the device 1. Components and functions, which correspond to those which have already been described above with reference to FIG. 1, have the same reference numerals and will not be discussed again in detail. The schematic view according to FIG. 7 differs in the degree of abstraction from that according to FIG. 1 to 3 and FIG. 5, 6.

A shut off valve 78 is also drawn in FIG. 7 in the outlet tube line 51. If this is closed, the concentrating mechanism 48 is inactive and the total granule-water flow flows through the granule heat exchanger 11.

In the device 77, the granule heat exchanger 11 is operated with a heat exchanger medium in the form of a salt solution guided in a circuit. Suitable heat exchanger media are lithium bromide or ionic liquids. At the entry of the granule heat exchanger 11, the temperature of the heat exchanger medium, which is fed to the granule heat exchanger 11 via the inlet 16, is still low. Accordingly, the salt concentration is low. In the granule heat exchanger 11, the heat exchanger medium absorbs heat from the granule-water flow, in other words from the temperature control mixture flow, and is heated in the granule heat exchanger 11 until it leaves the latter in liquid form via the outlet 19 with a high salt concentration. Owing to the heating of the heat exchanger medium in the granule heat exchanger 11, a part of the heat exchanger medium evaporates and leaves the granule heat exchanger 11 via a steam outlet 79.

The outlet 19 connects the granule heat exchanger 11 to a recuperator 80. The inlet 16 connects the recuperator 80 to the granule heat exchanger 11. The steam outlet 79 connects the granule heat exchanger 11 to the condenser 81. The steam is cooled therein with the aid of cooling water and condenses, the cooling water being fed to the condenser 81 via a cooling water inlet 82 and discharged via a cooling water outlet 83. The condenser 81 may be loaded with a vacuum and the condensate produced has a very low temperature in the range between 5° C. and 8° C. The condensate is removed from the condenser 81 via a condensate line 84. The latter can be closed by a shut off valve 85. The condensate is fed to an evaporator 86 from the condenser 81 via the condensate line 84. During evaporation, which can take place under negative pressure in the evaporator 86, the evaporating condensate cools a heat carrier medium, which is fed to the evaporator 86 via an inlet 87 and removed therefrom via an outlet 88. The heat carrier medium used in the evaporator 86 may in turn be water. The heat carrier medium, at the inlet 87, has a temperature of 14° C. and, at the outlet 88, depending on the temperature of the condensate fed to the evaporator 86, a temperature of, for example, 7° C. The lines 88 and 87 may be part of a cooling water circuit. During the production of cooling water in this circuit with the device 77, no compressor is necessary.

The steam removed from the evaporator 86 via a steam line 89 is returned in an absorber 90 into the salt solution heat carrier circuit. The content of the absorber 90 is cooled with cooling water, which is fed to the absorber via an inlet 91 and removed therefrom via an outlet 92. In the absorber 90, the salt solution is therefore present in the cold state. To circulate the salt solution in the salt solution heat exchanger circuit, a circulating pump 93 is used. The latter is arranged in a feed line 94, which connects the absorber 90 to the recuperator 80.

A mixing takes place in the recuperator 80 of the cold salt solution fed by the absorber 90 via the feed line 94 with the hot salt solution also fed to the recuperator 80 via the outlet 19. The salt solution with a mixing temperature, which is higher than the temperature of the salt solution in the feed line 94, is fed to the granule heat exchanger 11 via the inlet 16. The recuperator 80 has a fluid connection with the absorber 90 via a salt solution return line 95.

The heat of the granule-water flow in the granule heat exchanger 11 is used to remove heat from the heat carrier medium, in other words the salt solution. This removal of heat is used in the device 77 according to FIG. 7 in an absorption refrigerating system. The refrigerant, in the present example, the water, is ejected in the form of steam from the heat carrier medium, in other words the salt solution. The granule heat exchanger 11 in the device 77 is therefore also called the ejector.

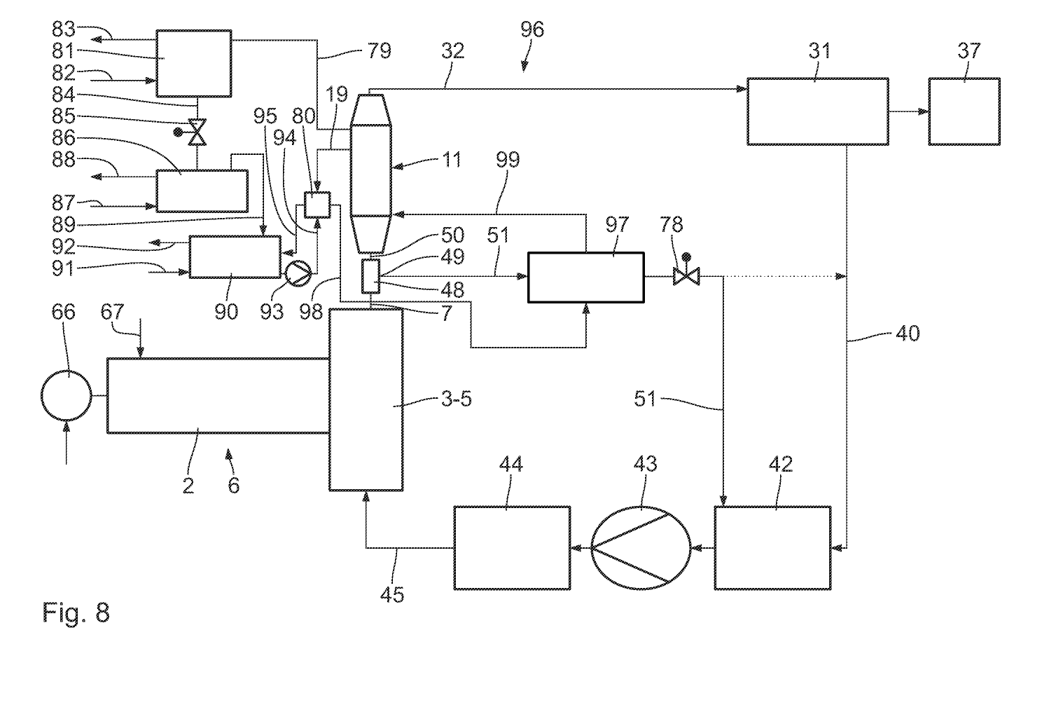

FIG. 8 shows a further configuration of a device 96 for producing granules made of polymeric materials, which can be used instead of the device 77. Components and functions, which correspond to those which have already been described above with reference to FIG. 1 to 7 and, in particular, with reference to FIG. 7, have the same reference numerals and will not be discussed again in detail.

In the configuration according to FIG. 8, arranged in the outlet tube line 51 is a preheat exchanger 97, which may also be a tube bundle heat exchanger. The preheat exchanger 97 absorbs heat from the granulating water, which is guided via the outlet tube line 51 through the preheat exchanger 97, and emits the latter to the salt solution heat carrier medium, which is fed to the preheat exchanger 97 via a feed line 98 and leaves the preheat exchanger 97 via a discharge line 99. The feed line 98 connects the recuperator 80 to the preheat exchanger 97. The discharge line 99 connects the preheat exchanger 97 to the granule heat exchanger 11 and is simultaneously its heat exchanger medium inlet.

Otherwise, the device 96 corresponds to the device 77.

FIG. 8 schematically shows that the outlet tube line 51 does not have to be directly connected to the cooling water tank 42, but can also open into the cooling water line 40.

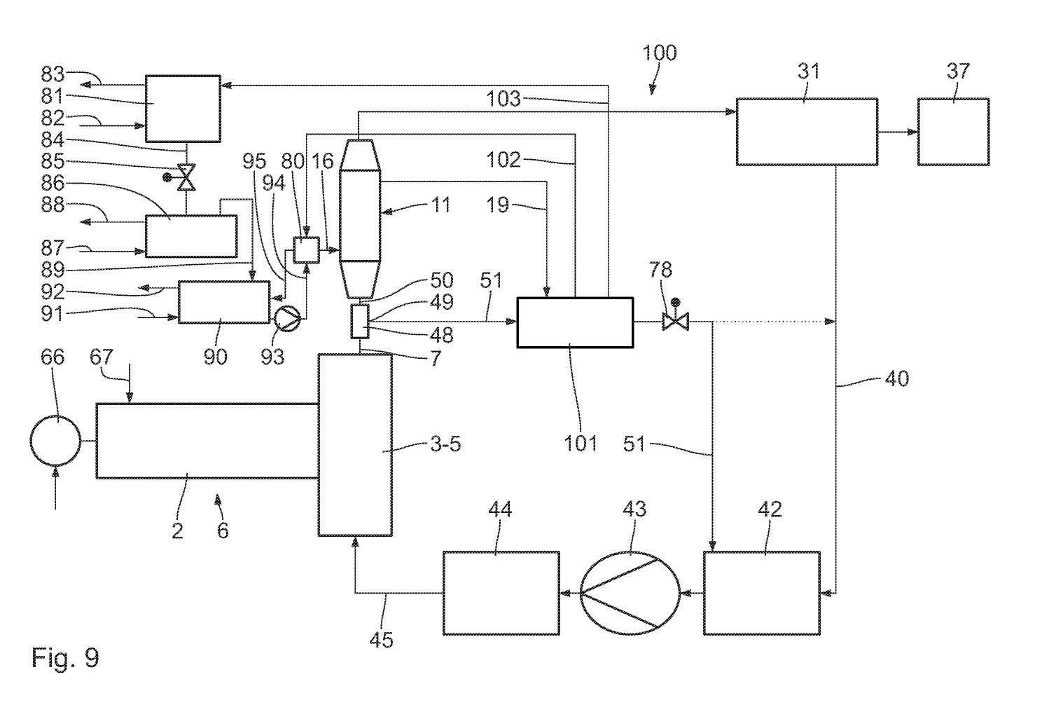

FIG. 9 shows a further configuration of a device 100 for producing granules made of polymeric materials, which can be used instead of the device 77. Components and functions, which correspond to those which have already been described above with reference to FIG. 1 to 8 and, in particular, with reference to FIGS. 7 and 8, have the same reference numerals and will not be discussed again in detail.

In the device 11, the preheat exchanger and the granule heat exchanger have exchanged roles with regard to the order of heating the salt solution heat carrier medium. The outlet 19 of the granule heat exchanger 11 has a fluid connection with an ejector heat exchanger 101, which is arranged in the device 100 at the site of the preheat exchanger 97 of the device 96 according to FIG. 8, in other words in the outlet tube line 51. The salt solution heated in the ejector heat exchanger 101 is returned to the recuperator 80 via a return line 102. A steam outlet 103 connects the ejector heat exchanger 101 to the condenser 81.

Otherwise, the device 100 according to FIG. 9 corresponds to the device 96 according to FIG. 8.

What is claimed is:

1. A device (1; 46; 47; 60; 65; 77; 96; 100) for producing granules made of polymeric materials
with a water-cooled granulating mechanism (6) for producing plastics material granules,
with a discharge line (7) arranged downstream of the granulating mechanism (6) for discharging a starting mixture flow containing the plastics material granules and cooling water,
with a granule heat exchanger (11) arranged downstream of the discharge line (7) for controlling the temperature of a temperature control mixture flow, containing the plastics material granules and at least a part of the cooling water,
wherein the granule heat exchanger (11) has an inlet (16; 99) for a transmission heat exchanger medium and an outlet (19) for a transmission heat exchanger medium,
with a drying mechanism (31) arranged downstream of the granule heat exchanger (11) for drying the plastics material granules,
wherein the granule heat exchanger (11) has a plurality of fluid passages (14) running in parallel, in other words not in series, for the temperature mixture flow.

2. A device according to claim 1, comprising a bypass line (10), which bridges the granule heat exchanger (11) between the granulating mechanism (6) and the drying mechanism (31).

3. A device according to claim 1, wherein the temperature control mixture flow is conveyed through the fluid passages (14) counter to an effect of gravity.

4. A device according to claim 1, wherein the temperature control mixture flow is conveyed through the fluid passages (14) under the influence of gravity.

5. A device according to claim 1, comprising a concentrating mechanism (48; 54), the entry of which is fed by the discharge line (7) and which
has a first exit (49) for a cooling water flow and
a second exit (50) for the temperature control mixture flow,
wherein
the first exit (49) of the concentrating mechanism (48; 54) has a fluid connection to a return line (51) for the cooling water to the granulating mechanism ((6),
the second exit (50) of the concentrating mechanism (48; 54) has a fluid connection to the granule heat exchanger (11).

6. A device according to claim 5, wherein the concentrating mechanism (54) at the entry of the granule heat exchanger (11) is integrated therein.

7. A device according to claim 5, wherein a cooling water heat exchanger (53; 97; 101) is arranged in the return line (51) between the concentrating mechanism (48, 54) and the granulating mechanism (6).

8. A device according to claim 1, wherein
the inlet (16) of the granule heat exchanger (11) for the transmission heat exchanger medium has a fluid connection to a separation line (61), which is arranged downstream of the drying mechanism (31), for separated cooling water,
the outlet (19) of the granule heat exchanger (11) for the transmission heat exchanger medium has a fluid connection to a return line (64) for the cooling water to the granulating mechanism (6).

9. A device (1; 46, 47; 65) for producing granules made of polymeric materials
with a water-cooled granulating mechanism (6) for producing plastics material granules,
with a discharge line (7) arranged downstream of the granulating mechanism (6) for discharging a starting mixture flow, containing the plastics material granules and cooling water,
with an energy recovery mechanism (18), which is arranged downstream of the discharge line (7), for recovering energy from a recovery cooling water flow, containing at least a part of the cooling water of the starting mixture flow,
wherein the energy recovery mechanism (18) comprises at least one ORC circuit (17) for an ORC circuit medium comprising:
an ORC turbine (22),
an ORC evaporator (11, 21; 11, 68) in the ORC circuit (17) before the ORC turbine (22),
an ORC condenser (24) in the ORC circuit (17) after the ORC-turbine (22).

10. A device according to claim 9, wherein the ORC evaporator (11, 21; 11, 68) has an ORC evaporator unit (21; 68) in the ORC circuit (17) before the ORC turbine (22) and an ORC preheater unit (11) in the ORC circuit (17) before the ORC evaporator unit (21; 68), one of the ORC evaporator unit (68) and the ORC preheater unit (11) being configured as a heat exchanger with the recovery cooling water flow.

11. A device according to claim 9, comprising
an ORC cooler (74) in the ORC circuit (17) between the ORC turbine (22) and the ORC condenser (24) for emitting heat from the ORC circuit medium to a transmission heat exchanger medium,
an ORC preliminary preheater (75) in the ORC circuit (17) between the ORC condenser (24) and the ORC evaporator (11, 68) for emitting heat from the transmission heat exchanger medium to the ORC circuit medium.

12. A device according to claim 9, comprising a concentrating mechanism (48), the entry of which is fed by the discharge line (7) and which
has a first exit (49) for a cooling water flow and
a second exit (50) for a mixture flow, containing plastics material granules and cooling water with a higher granule fraction than the starting mixture flow,
the first exit (49) of the concentrating mechanism (48) having a fluid connection to the ORC evaporator (68).

13. A device according to claim 10, wherein the ORC preheater unit (11) has a fluid connection to the second exit (50) of the concentrating mechanism (48).

14. A device according to claim 9, wherein the ORC circuit medium has one of an evaporation enthalpy in the range between 0 and 2600 kJ/kg and a heat capacity in the range between 0 and 6 kJ/kgK.

15. A device according to claim 9, comprising a bypass line (10), which bridges the energy recovery mechanism (18) between the granulating mechanism (6) and a drying mechanism (31).
